(19) United States
(12) Patent Application Publication
(10) Pub. No.: US 2018/0220043 A1
(43) Pub. Date: Aug. 2, 2018

(54) System That Performs Login Using Authentication Based on Face Image Included in Login System

(71) Applicant: Kyocera Document Solutions Inc., Osaka (JP)

(72) Inventors: Zhenyu Sun, Osaka (JP); Masafumi Sato, Osaka (JP); Yoshio Inoue, Osaka (JP)

(21) Appl. No.: 15/883,128

(22) Filed: Jan. 30, 2018

(30) Foreign Application Priority Data
Jan. 30, 2017 (JP) 2017-014487

(51) Int. Cl. H04N 1/44; H04N 1/00; G06F 21/32; G06K 9/00; G06F 21/62

(52) U.S. Cl. CPC H04N 1/442; H04N 1/00875; H04N 1/00854; G06K 9/00288; G06K 9/00255; G06F 21/6218; G06F 21/32

(57) ABSTRACT

A system includes an electronic device and a login system. The electronic device ensures a login in response to login information for a login received from outside of the system. The login system transmits the login information to the electronic device. The login system includes a camera, an authentication unit, a login information management unit, and an information transmitting unit. The authentication unit authenticates a user. The login information management unit manages the login information for each user. The information transmitting unit transmits the login information managed by the login information management unit for a user authenticated by the authentication unit, to the electronic device. The authentication unit authenticates the user based on a face image obtained with the camera.

### INCORPORATION BY REFERENCE

This application is based upon, and claims the benefit of priority from, corresponding Japanese Patent Application No. 2017-014487, filed in the Japanese Patent Office on Jan. 30, 2017, and the entire contents of which are incorporated herein by reference.

### BACKGROUND

Unless otherwise indicated herein, the description in this section is not prior art to the claims in this application and is not admitted to be prior art by inclusion in this section.

There is known an image processing apparatus that includes a camera and authentication means that authenticates a user based on a face image obtained with the camera, and that permits a login of the user who is authenticated by the authentication means.

### SUMMARY

A system according to one aspect of the disclosure includes an electronic device and a login system. The electronic device ensures a login in response to login information for a login received from outside of the system. The login system transmits the login information to the electronic device. The login system includes a camera, an authentication unit, a login information management unit, and an information transmitting unit. The authentication unit authenticates a user. The login information management unit manages the login information for each user. The information transmitting unit transmits the login information managed by the login information management unit for a user authenticated by the authentication unit, to the electronic device. The authentication unit authenticates the user based on a face image obtained with the camera.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1 illustrates a block diagram of a system according to a first embodiment of the disclosure.

FIG. 2 illustrates a block diagram of an MFP according to the first embodiment.

FIG. 3 illustrates a block diagram of a computer according to the first embodiment.

FIG. 4 illustrates a block diagram of a login server according to the first embodiment.

FIG. 5 illustrates a block diagram of an authentication server according to the first embodiment.

FIG. 6 illustrates an operation of the computer according to the first embodiment instructed to start a login process to the MFP via an operation unit.

FIG. 7 illustrates an operation of a system according to the first embodiment when a combination of a face image and a card ID is transmitted to the login server from the computer.

FIG. 8 illustrates a block diagram of a system according to a second embodiment of the disclosure.

FIG. 9 illustrates a block diagram of a mobile device according to the second embodiment.

FIG. 10 illustrates an operation of the mobile device according to the second embodiment instructed to start a login process to the MFP via an operation unit.

FIG. 11 illustrates an operation of a system according to the second embodiment when an authentication of a user is requested to the authentication server from the mobile device.

### DETAILED DESCRIPTION

Example apparatuses are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

The following describes an embodiment of the disclosure by referring to the drawings.

### First Embodiment

First, a configuration of a system according to a first embodiment of the disclosure will be described.

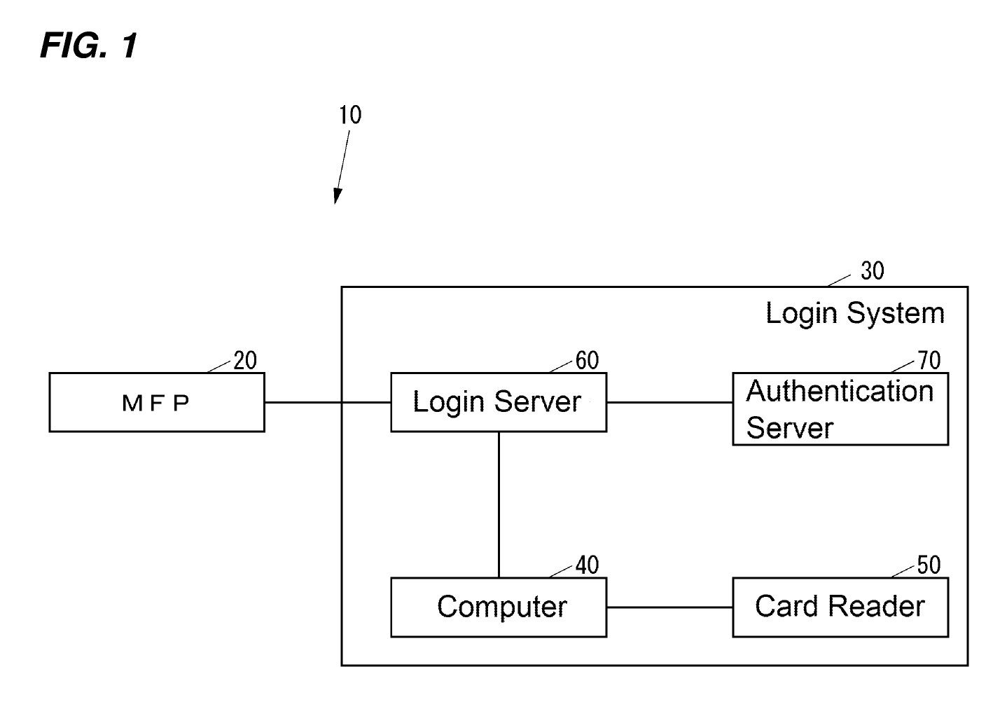

FIG. 1 illustrates a block diagram of a system 10 according to the embodiment.

as illustrated in FIG. 1, the system 10 includes a multifunction peripheral (MFP) 20 as an electronic device and a login system 30 that transmits login information for a login to the MFP 20 to the MFP 20.

The login system 30 includes a computer 40, a card reader 50, a login server 60, and an authentication server 70. The computer 40 is installed beside the MFP 20. The card reader 50 is, for example, an integrated circuit (IC) card reader connected to the computer 40. The login server 60 transmits the login information to the MFP 20. The authentication server 70 authenticates a user.

Other than the MFP 20, the system 10 may include one or more MFP similar to the MFP 20. Similarly, other than a combination of the computer 40 and the card reader 50, the login system 30 may include one or more combination of a computer and a card reader similar to the combination of the computer 40 and the card reader 50. When a plurality of the MFPs and a plurality of the computers are included in the system 10, the combination of the MFP and the computer used to log in to this MFP is fixed.

The login server 60 is configured to communicate with each of the MFP 20, the computer 40, and the authentication server 70 via a network, such as the Internet.

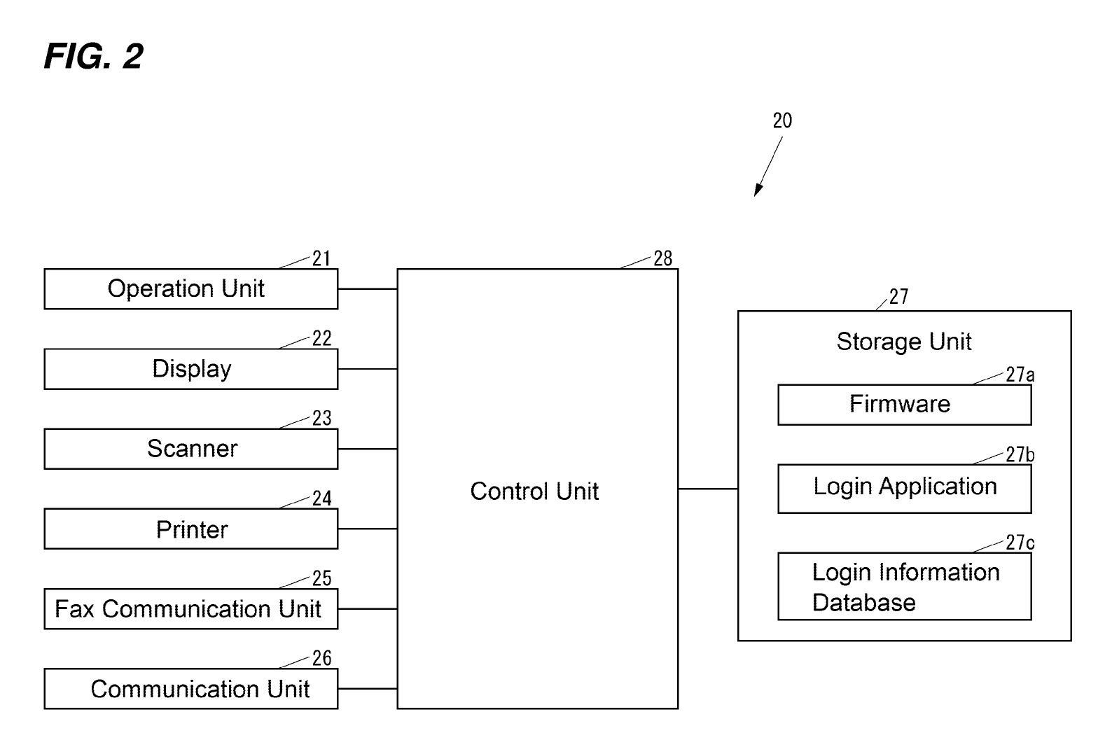

FIG. 2 illustrates a block diagram of the MFP 20.

As illustrated in FIG. 2, the MFP 20 includes an operation unit 21, a display 22, a scanner 23, a printer 24, a fax communication unit 25, a communication unit 26, a storage unit 27, and a control unit 28. The operation unit 21 is an input device, such as a button, with which various kinds of operations are input. The display 22 is a display device, such as a liquid crystal display (LCD), that displays various pieces of information. The scanner 23 is a reading device that reads an image from a document. The printer 24 is a print device that prints an image on a recording medium, such as a paper sheet. The fax communication unit 25 is a facsimile device that performs a fax communication via a communication line, such as an external facsimile device and a dial-up line, which are not illustrated. The communication unit 26 is a communication device that communicates with an external device via the network or directly with wire or wireless without the network. The storage unit 27 is a non-volatile storage device, such as a semiconductor memory and a hard disk drive (HDD), which stores various pieces of information. The control unit 28 controls the whole MFP 20.

The storage unit 27 stores a firmware 27a and a login application 27b that operates on the firmware 27a. Each of the firmware 27a and the login application 27b may be installed on the MFP 20 at production stage of the MFP 20, may be additionally installed on the MFP 20 from an external storage medium, such as a universal serial bus (USB) memory, or may be additionally installed on the MFP 20 from the network.

The firmware 27a includes a function that brings the operation unit 21 into an unusable state when the user is not logged in to the MFP 20.

The storage unit 27 stores a login information database 27c that includes the login information for each user.

The control unit 28 includes, for example, a central processing unit (CPU), a read-only memory (ROM), and a random-access memory (RAM). The ROM stores programs and various data. The RAM is used as a work area for the CPU. The CPU executes the program stored in the ROM or the storage unit 27.

When a user having a specific authority is being logged in to the MFP 20, and then this user inputs a request of adding, changing, or deleting the login information of this user or another user via the operation unit 21 or the communication unit 26, the control unit 28 edits the login information database 27c in accordance with this request.

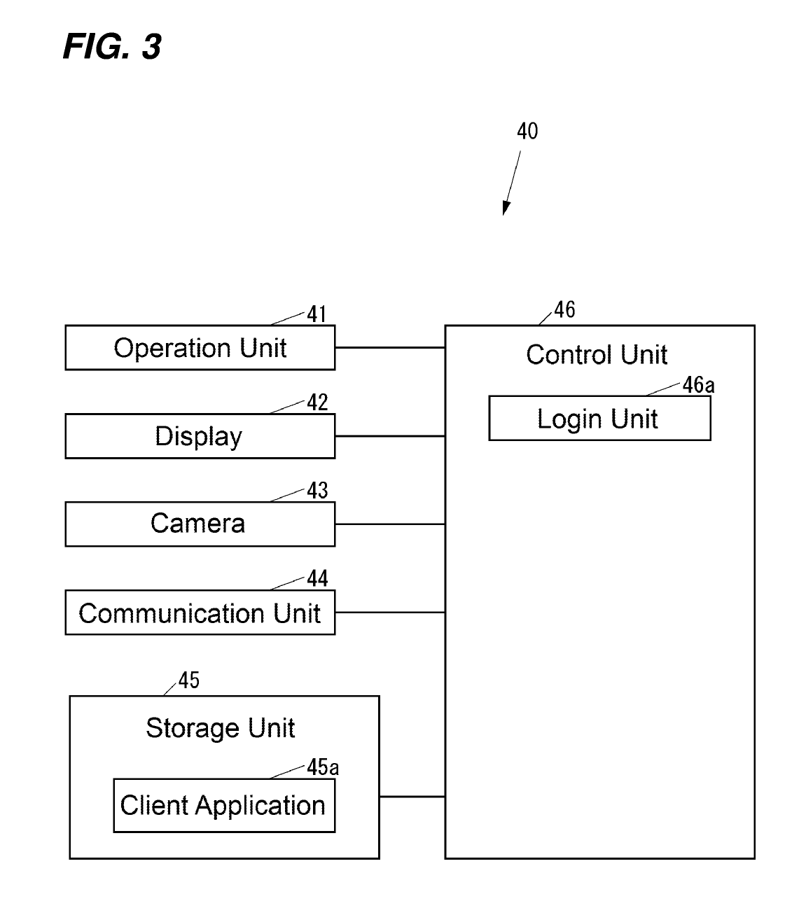

FIG. 3 illustrates a block diagram of the computer 40.

As illustrated in FIG. 3, the computer 40 includes an operation unit 41, a display 42, a camera 43, a communication unit 44, a storage unit 45, and a control unit 46. The operation unit 41 is an input device, such as a keyboard and a mouse, with which various kinds of operations are input. The display 42 is a display device, such as an LCD, that displays various pieces of information. The communication unit 44 is a communication device that communicates with an external device via the network or directly with wire or wireless without the network. The storage unit 45 is a non-volatile storage device, such as a semiconductor memory and an HDD, which stores various pieces of information. The control unit 46 controls the whole computer 40. The computer 40 may be constituted of, for example, a laptop personal computer (PC).

While the computer 40 has the camera 43 built in, the camera 43 may be externally attached. While the computer 40 has the card reader 50 (see FIG. 1) externally attached, the card reader 50 may be built-in.

The storage unit 45 stores a client application 45a. The client application 45a may be installed on the computer 40 at production stage of the computer 40, may be additionally installed on the computer 40 from an external storage medium, such as a compact disk (CD), a digital versatile disk (DVD), and a USB memory, or may be additionally installed on the computer 40 from the network.

The control unit 46 includes, for example, a CPU, a ROM, and a RAM. The ROM stores programs and various data. The RAM is used as a work area of the CPU. The CPU executes the program stored in the ROM or the storage unit 45.

The control unit 46 executes the client application 45a to achieve a login unit 46a that executes a login process to the MFP 20.

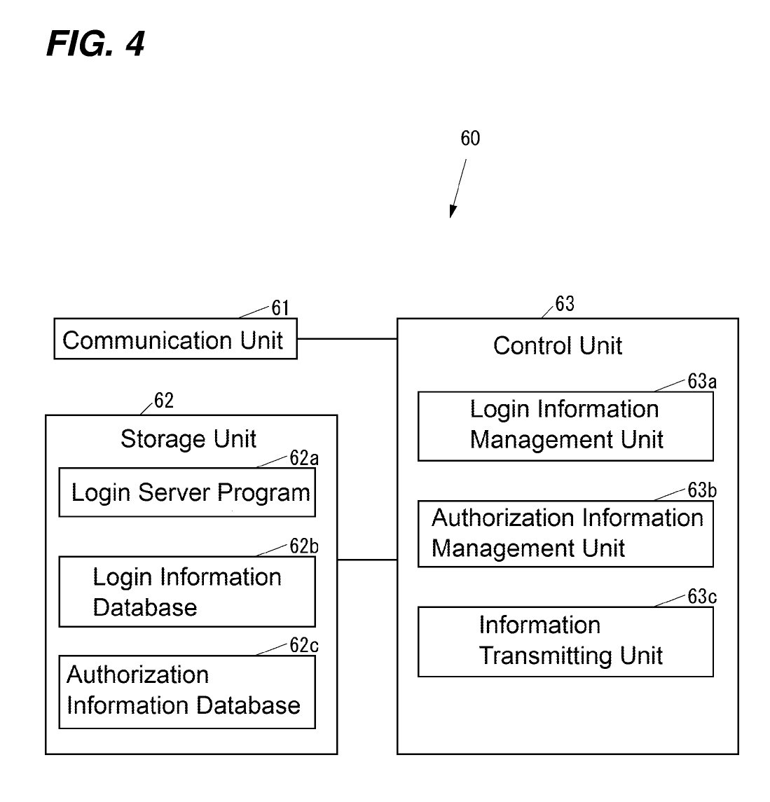

FIG. 4 illustrates a block diagram of the login server 60.

As illustrated in FIG. 4, the login server 60 includes a communication unit 61, a storage unit 62, and a control unit 63. The communication unit 61 is a communication device that communicates with an external device via the network or directly with wire or wireless without the network. The storage unit 62 is a non-volatile storage device, such as a semiconductor memory and an HDD, which stores various pieces of information. The control unit 63 controls the whole login server 60.

The storage unit 62 stores a login server program 62a. The login server program 62a may be installed on the login server 60 at production stage of the login server 60, may be additionally installed on the login server 60 from an external storage medium, such as a CD, a DVD, and a USB memory, or may be additionally installed on the login server 60 from the network.

The storage unit 62 stores a login information database 62b that includes the login information for each user. In the login information database 62b, the login information of a user is associated with a specific identification information (hereinafter referred to as a “specific ID”) of the user. Here, the specific ID of the user may be a card ID of a card of the user.

The storage unit 62 stores an authorization information database 62c that includes authorization information indicating a restriction with respect to the MFP for each user. Here, the authorization information includes, for example, information that indicates the permitted number of copies in the MFP. In the authorization information database 62c, the authorization information of the user is associated with the specific ID of the user.

The control unit 63 includes, for example, a CPU, a ROM, and a RAM. The ROM stores programs and various data. The RAM is used as a work area of the CPU. The CPU executes the program stored in the ROM or the storage unit 62.

The control unit 63 executes the login server program 62a to achieve a login information management unit 63a, an authorization information management unit 63b, and an information transmitting unit 63c. The login information management unit 63a manages the login information database 62b. The authorization information management unit 63b manages the authorization information database 62c. The information transmitting unit 63c transmits the login information and the authorization information to the MFP.

When a user having a specific authority is being logged in to the login server 60, and then this user inputs a request of adding, changing, or deleting the login information of this user or another user via the communication unit 61, the login information management unit 63a edits the login information database 62b in accordance with this request.

When the user having the specific authority is being logged in to the login server 60, and then this user inputs a request of adding, changing, or deleting the authorization information of this user or another user via the communication unit 61, the authorization information management unit 63b edits the authorization information database 62c in accordance with this request.

The example of one computer constituting the login server 60 has been described above. However, the login server 60 may be achieved by, for example, a cloud server.

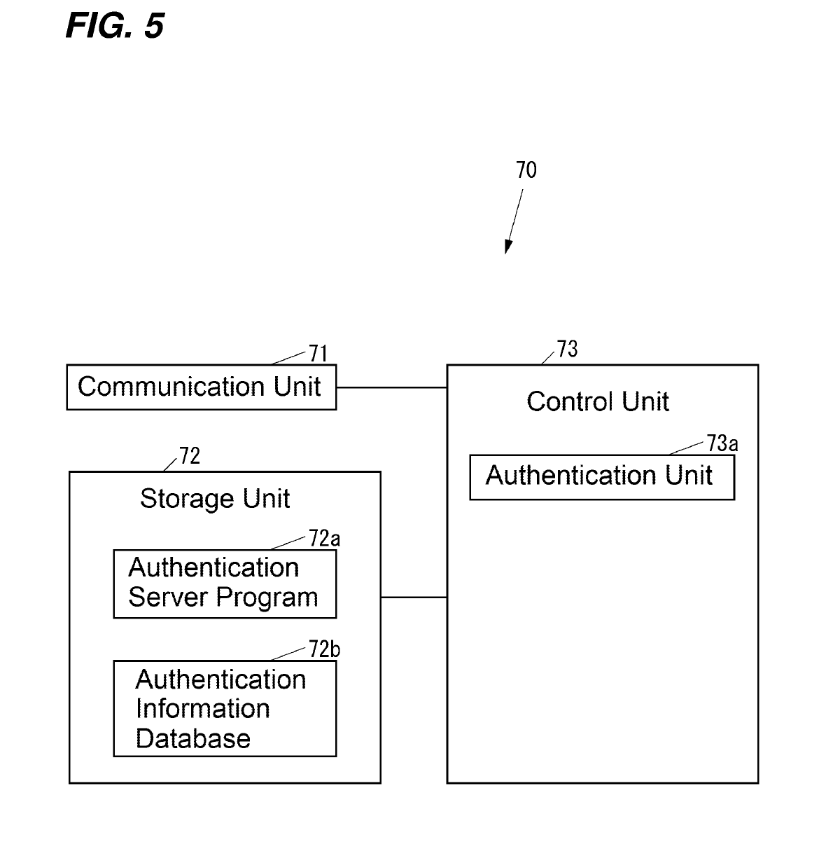

FIG. 5 illustrates a block diagram of the authentication server 70.

As illustrated in FIG. 5, the authentication server 70 includes a communication unit 71, a storage unit 72, and a control unit 73. The communication unit 71 is a communication device that communicates with an external device via the network or directly with wire or wireless without the network. The storage unit 72 is a non-volatile storage device, such as a semiconductor memory, an HDD, that stores various pieces of information. The control unit 73 controls the whole authentication server 70.

The storage unit 72 stores an authentication server program 72a. The authentication server program 72a may be installed on the authentication server 70 at production stage of the authentication server 70, may be additionally installed on the authentication server 70 from an external storage medium, such as a CD, a DVD, and a USB memory, or may be additionally installed on the authentication server 70 from the network.

The storage unit 72 stores an authentication information database 72b including a combination of a face image of a user, a card ID of the user, and a specific ID of the user for each user.

The control unit 73 includes, for example, a CPU, a ROM, and a RAM. The ROM stores programs and various data. The RAM is used as a work area of the CPU. The CPU executes the program stored in the ROM or the storage unit 72.

The control unit 73 executes the authentication server program 72a to achieve an authentication unit 73a that authenticates a user.

When a user having a specific authority is being logged in to the authentication server 70, and then this user inputs a request of adding or deleting a combination of a face image, a card ID, and a specific ID of this user or another user, and a request of changing at least one of the face image, the card ID and the specific ID via the communication unit 71, the control unit 73 edits the authentication information database 72b in accordance with this request.

The example of one computer constituting the authentication server 70 has been described above. However, the authentication server 70 may be achieved by, for example, a cloud server.

Next, the following describes an operation of the system 10 when a login to the MFP 20 is performed via the login system 30.

First, the following describes an operation of the computer 40 instructed to start a login process to the MFP 20 via the operation unit 41.

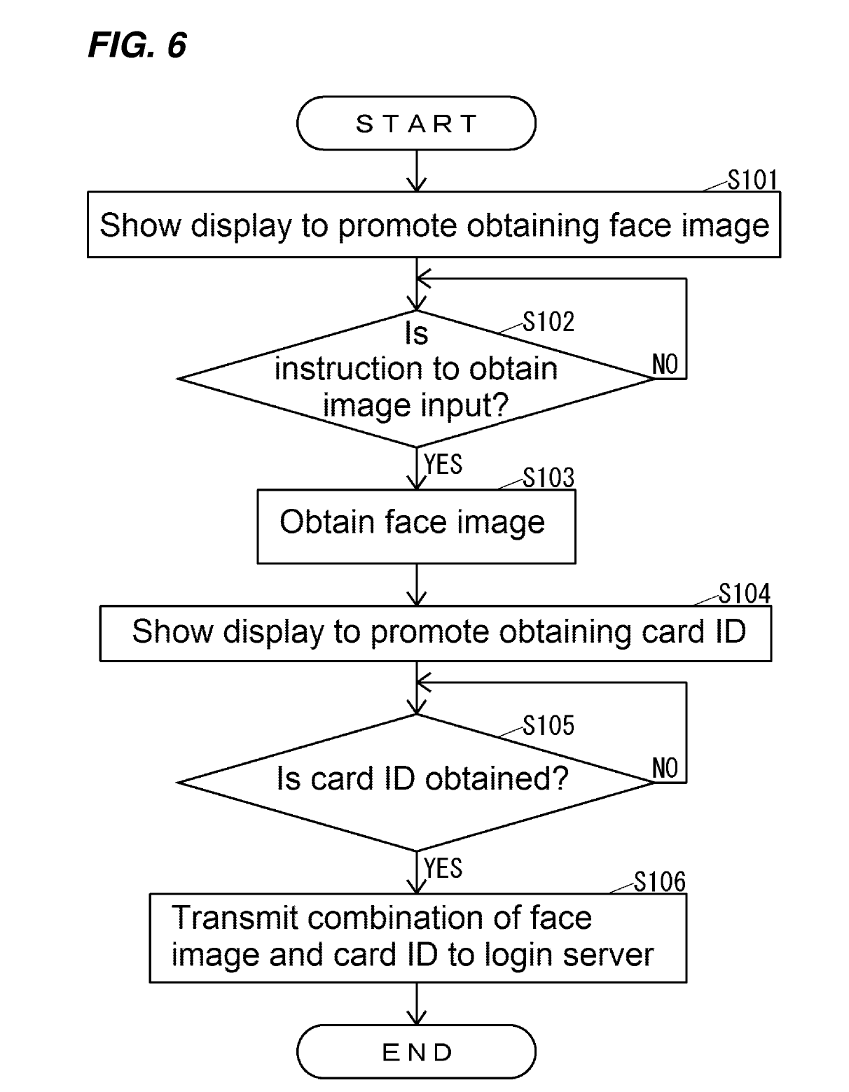

FIG. 6 illustrates the operation of the computer 40 instructed to start the login process to the MFP 20 via the operation unit 41.

Upon being instructed to start the login process to the MFP 20 via the operation unit 41, the login unit 46a of the computer 40 executes the operation illustrated in FIG. 6.

As illustrated in FIG. 6, the login unit 46a shows a display to promote obtaining a face image of a user with the camera 43 on the display 42 (Step S101).

Next, until determining that the instruction to obtain the image with the camera 43 is input via the operation unit 41, the login unit 46a determines whether the instruction to obtain the image with the camera 43 is input via the operation unit 41 or not (Step S102).

The login unit 46a is configured to display an animated film being captured with the camera 43 on at least a part of a region on the display 42. Accordingly, the user can change a position of the face of the user himself/herself relative to the camera 43 such that the face of the user himself/herself is positioned within a range captured with the camera 43 by confirming the animated film displayed on the display 42. Then, the user can input the instruction to obtain the image with the camera 43 via the operation unit 41 in a state where the face of the user himself/herself is positioned within the range captured with the camera 43.

Upon determining that the instruction to obtain the image with the camera 43 is input via the operation unit 41 at Step S102, the login unit 46a obtains the image being captured with the camera 43 (Step S103). That is, the login unit 46a is configured to obtain the face image of the user with the camera 43.

The login unit 46a shows a display to promote obtaining a card ID of the user with the card reader 50 on the display 42 after the process at Step S103 (Step S104).

Next, until determining that the card ID is obtained with the card reader 50 after the process at Step S104, the login unit 46a determines whether the card ID is obtained with the card reader 50 or not (Step S105).

Here, the card reader 50 is configured to obtain the card ID from a card of the user by the card of the user passed over the card reader 50. When the card ID is obtained, the card reader 50 notifies the computer 40 of the obtainment of the card ID. Accordingly, the login unit 46a is configured to determine that the card ID is obtained with the card reader 50 based on the notification from the card reader 50.

Upon determining that the card ID is obtained with the card reader 50 at Step S105, the login unit 46a transmits a combination of the face image obtained at Step S103 and the card ID obtained with the card reader 50 to the login server 60 (Step S106), and terminates the operation illustrated in FIG. 6.

Next, the following describes an operation of the system 10 when the combination of the face image and the card ID is transmitted from the computer 40 to the login server 60.

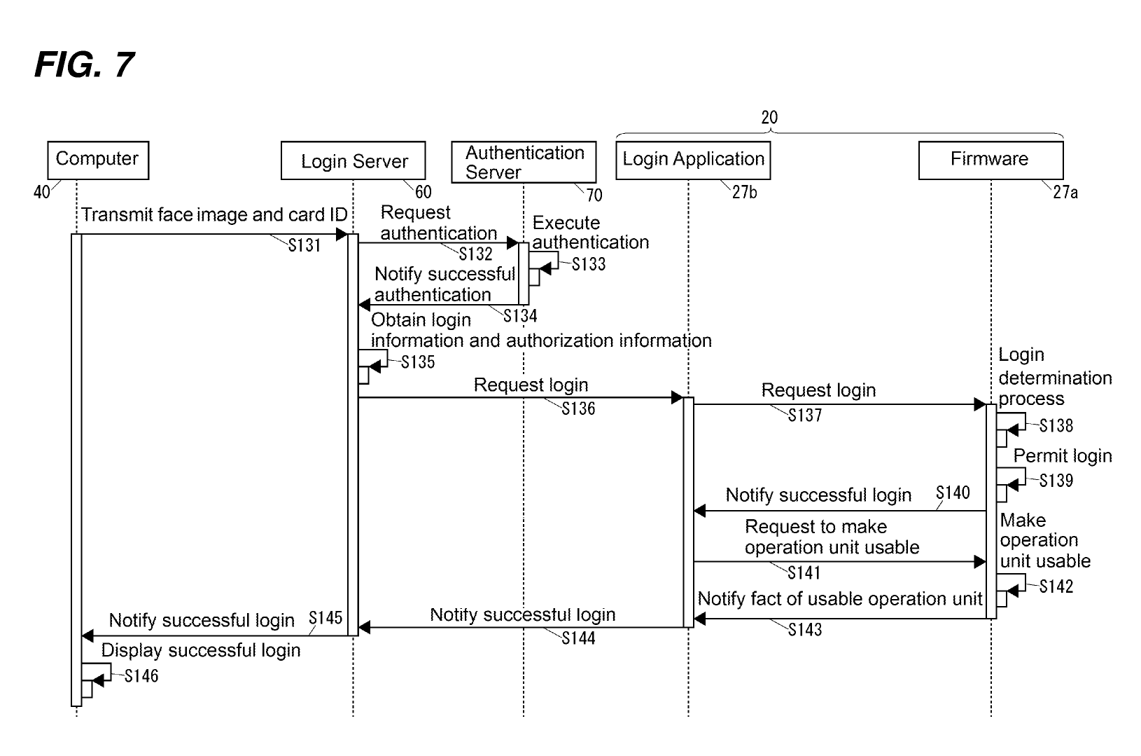

FIG. 7 illustrates the operation of the system 10 when the combination of the face image and the card ID is transmitted from the computer 40 to the login server 60.

As illustrated in FIG. 7, as soon as the combination of the face image and the card ID is transmitted from the computer 40 to the login server 60 by the process of Step S106 (Step S131), the information transmitting unit 63c of the login server 60 requests an authentication of the user based on the combination of the face image and the card ID transmitted from the computer 40 at Step S131 to the authentication server 70 (Step S132).

Accordingly, the authentication unit 73a of the authentication server 70 executes the authentication of the user based on the combination of the face image and the card ID transmitted from the login server 60 at Step S132 and the authentication information database 72b (Step S133). Here, the authentication unit 73a determines that the authentication of the user is successful when the combination of the face image and the card ID transmitted from the login server 60 at Step S132 is stored in the authentication information database 72b. On the other hand, the authentication unit 73a determines that the authentication of the user fails when the combination of the face image and the card ID transmitted from the login server 60 at Step S132 is not stored in the authentication information database 72b.

Upon determining the successful authentication of the user, the authentication unit 73a notifies the login server 60 of the fact of the successful authentication of the user and the specific ID of the user successfully authenticated, that is, the specific ID associated in the authentication information database 72b with the combination of the face image and the card ID transmitted from the login server 60 at Step S132 (Step S134).

Accordingly, the information transmitting unit 63c of the login server 60 obtains the login information and the authorization information of the user based on the specific ID notified from the authentication server 70 at Step S134 and the login information database 62b and the authorization information database 62c (Step S135). Specifically, the information transmitting unit 63c obtains the login information associated in the login information database 62b with the specific ID notified from the authentication server 70 at Step S134 and obtains the authorization information associated in the authorization information database 62c with this specific ID.

Next, the information transmitting unit 63c requests the login application 27b of the MFP 20 to perform a login in response to the login information and the authorization information obtained at Step S135 (Step S136).

As soon as the login is requested from the login server 60 at Step S136, the login application 27b requests the firmware 27a to perform the login in response to the login information and the authorization information transmitted from the login server 60 at Step S136 (Step S137). Accordingly, the firmware 27a executes a login determination process that determines whether the login is permitted or not based on the login information transmitted from the login server 60 at Step S136 and the login information database 27c (Step S138). Here, when the login information transmitted from the login server 60 at Step S136 is included in the login information database 27c, the firmware 27a determines that the login of the user is permitted. On the other hand, when the login information transmitted from the login server 60 at Step S136 is not included in the login information database 27c, the firmware 27a determines that the login of the user is not permitted.

When determining the login of the user is permitted, the firmware 27a executes a restriction in accordance with the authorization information transmitted from the login server 60 at Step S136 to permit the login of the user (Step S139), and notifies the login application 27b of the successful login of the user (Step S140).

Upon being notified of the successful login of the user from the firmware 27a, the login application 27b requests a request to bring the operation unit 21 into an usable state to the firmware 27a (Step S141). Accordingly, after bringing the operation unit 21 into the usable state (Step S142), the firmware 27a notifies the login application 27b of the fact that the operation unit 21 is brought into the usable state (Step S143). Then, upon being notified of the fact that the operation unit 21 is brought into the usable state from the firmware 27a, the login application 27b notifies the login server 60 of the successful login of the user (Step S144).

Upon being notified of the successful login of the user from the MFP 20 at Step S144, the information transmitting unit 63c of the login server 60 notifies the computer 40 of the successful login of the user (Step S145). Accordingly, the login unit 46a of the computer 40 displays the successful login to the MFP 20 on the display 42 (Step S146).

When the authentication of the user fails at Step S133, the authentication unit 73a notifies the login server 60 of the fact of the failed authentication of the user. Upon being notified of the fact of the failed authentication of the user from the authentication server 70, the information transmitting unit 63c of the login server 60 notifies the computer 40 of the fact of the failed authentication of the user. Accordingly, the login unit 46a of the computer 40 displays the fact of the failed login to the MFP 20 due to the failed authentication of the user on the display 42.

When determining that the login of the user is not permitted at Step S138, the firmware 27a notifies the login application 27b of the failed login of the user. Accordingly, the login application 27b notifies the login server 60 of the failed login of the user. Upon being notified of the failed login of the user from the MFP 20, the information transmitting unit 63c of the login server 60 notifies the computer 40 of the failed login of the user. Accordingly, the login unit 46a of the computer 40 displays the fact that the login of the user is not permitted by the MFP 20 on the display 42.

As described above, the system 10 executes the authentication based on the face image in the login system 30 that transmits the login information to the MFP 20, thereby ensuring the login by the authentication based on the face image even when the MFP 20 is one that is not configured to execute the authentication based on the face image.

When the login to the MFP 20 is performed by the authentication based on the face image, the system 10 applies the restriction with respect to the MFP 20 depending on the user (Step S139), thereby ensuring improving the convenience. The system 10 does not have to support the execution of the restriction in accordance with the authorization information.

The login system 30 executes the authentication based not only on the face image but also on the card ID in this embodiment. However, the login system 30 does not have to use the card ID for the authentication. The login system 30 may execute the authentication based on the face image of the user and identification information of the user other than the card ID, such as personal identification number (PIN) code. The PIN code may be input from the operation unit 41.

The computer 40 may include at least a part of functions of at least one of the login server 60 and the authentication server 70. When the computer 40 includes all the functions of both the login server 60 and the authentication server 70, the system 10 does not have to include the login server 60 and the authentication server 70.

### Second Embodiment

First, the following describes a configuration of a system according to a second embodiment of the disclosure.

In the configuration of the system according to the embodiment, like reference numerals of the configuration of the system 10 according to the first embodiment (see FIG. 1) are designated to the configuration similar to the configuration of the system 10 and will not be further elaborated here.

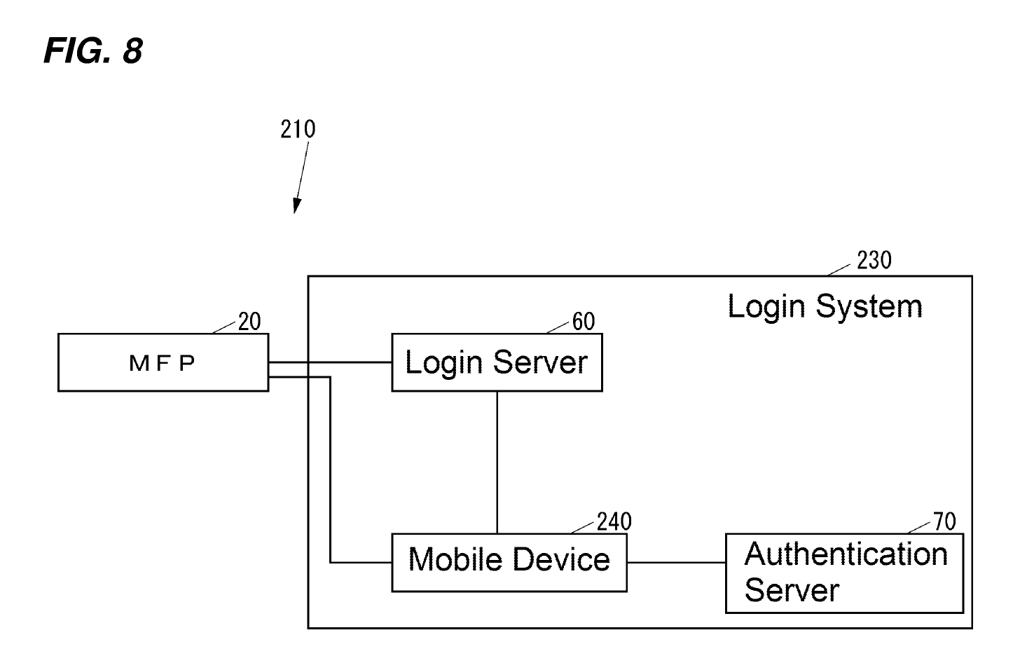

FIG. 8 illustrates a block diagram of a system 210 according to the embodiment.

As illustrated in FIG. 8, the system 210 includes the MFP 20 and a login system 230 that transmits the login information for a login to the MFP 20 to the MFP 20.

The login system 230 includes a mobile device 240, the login server 60, and the authentication server 70. The mobile device 240 is carried by a user. The login server 60 transmits the login information to the MFP 20. The authentication server 70 authenticates the user.

Other than the MFP 20, the system 210 may include one or more MFP similar to the MFP 20. Similarly, other than the mobile device 240, the login system 230 may include one or more mobile device similar to the mobile device 240.

The mobile device 240 is configured to communicate with each of the MFP 20, the login server 60, and the authentication server 70 via the network, such as the Internet.

The authentication information database 72b of the authentication server 70 of the login system 230 includes a combination of a face image of a user and a specific ID of the user for each user, not the combination of the face image of the user, the card ID of the user, and the specific ID of the user.

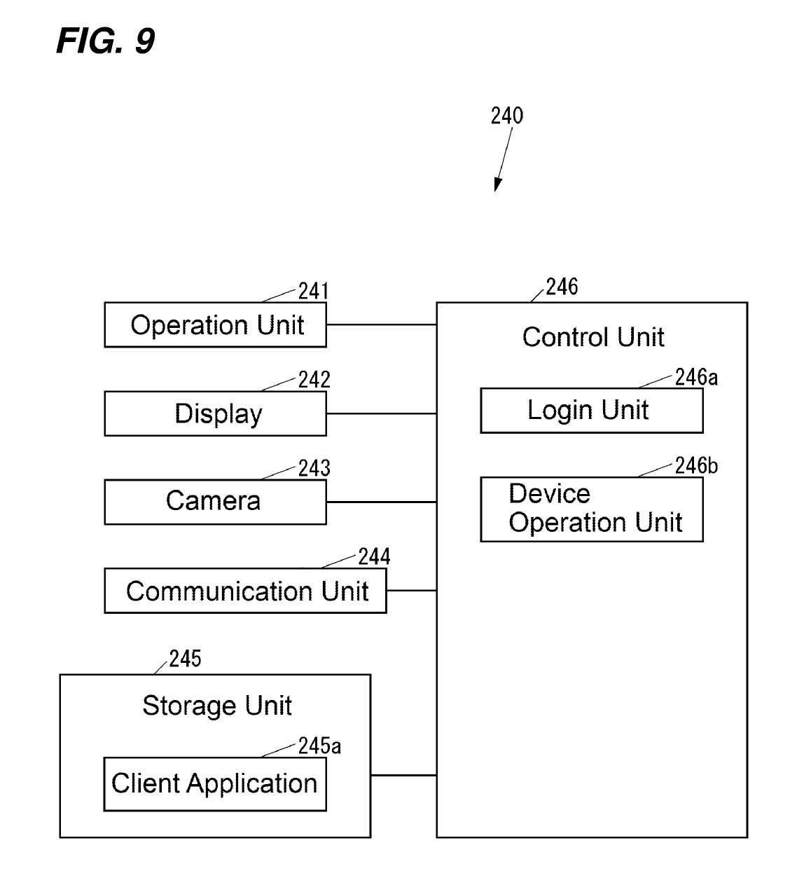

FIG. 9 illustrates a block diagram of the mobile device 240.

As illustrated in FIG. 9, the mobile device 240 includes an operation unit 241, a display 242, a camera 243, a communication unit 244, a storage unit 245, and a control unit 246. The operation unit 241 is an input device, such as a button, with which various kinds of operations are input. The display 242 is a display device, such as an LCD, that displays various pieces of information. The communication unit 244 is a communication device that communicates with an external device via the network or directly with wire or wireless without the network. The storage unit 245 is a non-volatile storage device, such as a semiconductor memory and an HDD, which stores various pieces of information. The control unit 246 controls the whole mobile device 240. The mobile device 240 may be constituted of, for example, a smart phone and a tablet.

The storage unit 245 stores a client application 245a. The client application 245a may be installed on the mobile device 240 at production stage of the mobile device 240, may be additionally installed on the mobile device 240 from an external storage medium, such as a CD, a DVD, and a USB memory, or may be additionally installed on the mobile device 240 from the network.

The control unit 246 includes, for example, a CPU, a ROM, and a RAM. The ROM stores programs and various data. The RAM is used as a work area of the CPU. The CPU executes the program stored in the ROM or the storage unit 245.

The control unit 246 achieves a login unit 246a and a device operation unit 246b. The login unit 246a executes the login process to the MFP by executing the client application 245a. The device operation unit 246b operates the MFP in accordance with an input accepted by the operation unit 241.

Next, the following describes an operation of the system 210 when the login to the MFP 20 is performed via the login system 230.

The user can instruct to start the login process to the MFP 20 via the operation unit 241 after specifying the MFP 20 via the operation unit 241.

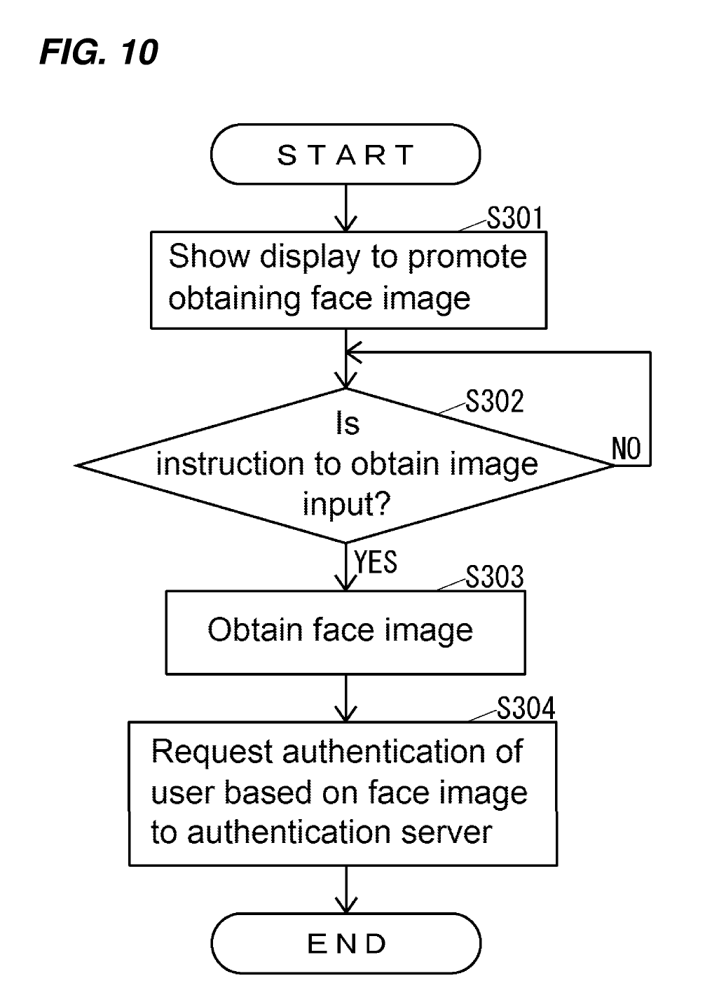

FIG. 10 illustrates an operation of the mobile device 240 instructed to start the login process to the MFP 20 via the operation unit 241.

As illustrated in FIG. 10, upon being instructed to start the login process to the MFP 20 via the operation unit 241, after obtaining a face image with the camera 243 (Steps S301 to S303), similarly to Steps S101 to S103 in the first embodiment, the login unit 246a of the mobile device 240 requests the authentication server 70 to authenticate the user based on the obtained face image (Step S304), and terminates the operation illustrated in FIG. 10.

Next, the following describes an operation of the system 210 when the authentication of the user is requested from the mobile device 240 to the authentication server 70.

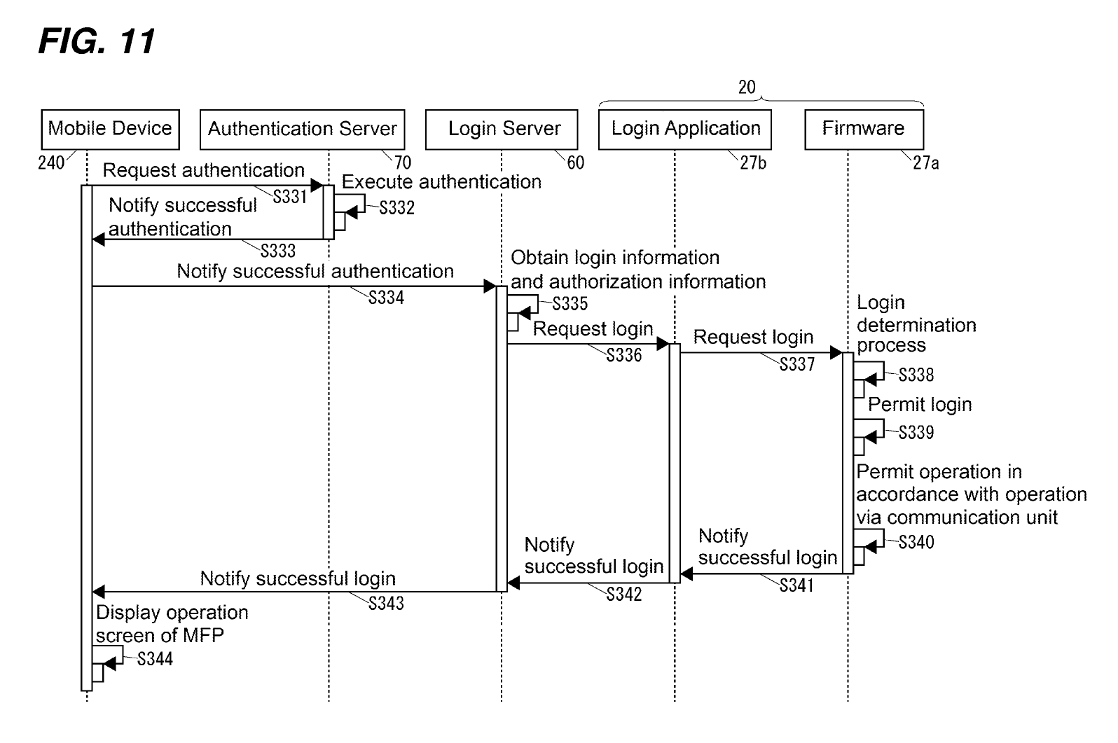

FIG. 11 illustrates the operation of the system 210 when the authentication of the user is requested from the mobile device 240 to the authentication server 70.

As illustrated in FIG. 11, as soon as the authentication server 70 is requested from the mobile device 240 to authenticate the user by the process at Step S304 (Step S331), the authentication unit 73a of the authentication server 70 executes the authentication of the user based on the face image transmitted from the mobile device 240 at Step S331 and the authentication information database 72b (Step S332). Here, the authentication unit 73a determines that the authentication of the user is successful when the face image transmitted from the mobile device 240 at Step S331 is stored in the authentication information database 72b. On the other hand, the authentication unit 73a determines that the authentication of the user fails when the face image transmitted from the mobile device 240 at Step S331 is not stored in the authentication information database 72b.

Upon determining the successful authentication of the user, the authentication unit 73a notifies the mobile device 240 of the fact of the successful authentication of the user and the specific ID of the user successfully authenticated, that is, the specific ID associated in the authentication information database 72b with the face image transmitted from the login server 60 at Step S331 (Step S333). Upon being notified of the fact of the successful authentication of the user and the specific ID of the user successfully authenticated from the authentication server 70, the login unit 246a of the mobile device 240 notifies the login server 60 of the fact of the successful authentication of the user and the specific ID of the user successfully authenticated (Step S334).

Accordingly, the information transmitting unit 63c of the login server 60 obtains the login information and the authorization information of the user based on the specific ID notified from the mobile device 240 at Step S334, and the login information database 62b and the authorization information database 62c, similarly to the process at Step S135 (Step S335).

Next, the information transmitting unit 63c requests the login application 27b of the MFP 20 for the login in response to the login information and the authorization information obtained at Step S335 (Step S336).

Upon being requested for the login from the login server 60 at Step S336, the login application 27b requests the firmware 27a for the login in response to the login information and the authorization information transmitted from the login server 60 at Step S336 (Step S337). Accordingly, the firmware 27a executes the login determination process that determines whether the login is permitted or not based on the login information transmitted from the login server 60 at Step S336 and the login information database 27c, similarly to the process at Step S138 (Step S338).

When determining that the login of the user is permitted, the firmware 27a executes a restriction in accordance with the authorization information transmitted from the login server 60 at Step S336 to permit the login of the user (Step S339), and thereafter, permits the operation of the MFP 20 in accordance with the operation by the user who is permitted to log in at Step S339 via the communication unit 26 (Step S340), and notifies the login application 27b of the successful login of the user (Step S341). Then, upon being notified of the successful login of the user from the firmware 27a, the login application 27b notifies the login server 60 of the successful login of the user (Step S342).

Upon being notified of the successful login of the user from the MFP 20 at Step S342, the information transmitting unit 63c of the login server 60 notifies the mobile device 240 of the successful login of the user (Step S343). Upon being notified of the successful login of the user from the login server 60, the device operation unit 246b of the mobile device 240 displays an operation screen to operate the MFP 20 on the display 242 (Step S344). Accordingly, after the process at Step S344, when the operation screen displayed on the display 242 is operated via the operation unit 241, the device operation unit 246b transmitting an operation content to the MFP 20 ensures causing the MFP 20 to execute the operation in accordance with this operation content.

When the authentication of the user fails at Step S332, the authentication unit 73a notifies the mobile device 240 of the fact of the failed authentication of the user. Accordingly, the login unit 246a of the mobile device 240 displays the fact of the failed login to the MFP 20 due to the failed authentication of the user on the display 242.

When determining that the login of the user is not permitted at Step S338, the firmware 27a notifies the login application 27b of the failed login of the user. Accordingly, the login application 27b notifies the login server 60 of the failed login of the user. Upon being notified of the failed login of the user from the MFP 20, the information transmitting unit 63c of the login server 60 notifies the mobile device 240 of the failed login of the user. Accordingly, the login unit 246a of the mobile device 240 displays the fact that the login of the user is not permitted by the MFP 20 on the display 242.

As described above, the system 210 executes the authentication based on the face image in the login system 230 that transmits the login information to the MFP 20, thereby ensuring the login by the authentication based on the face image even when the MFP 20 is one that is not configured to execute the authentication based on the face image.

When login to the MFP 20 is performed by the authentication based on the face image, the system 210 applies the restriction with respect to the MFP 20 depending on the user (Step S339), thereby ensuring improving the convenience. The system 210 does not have to support the execution of the restriction in accordance with the authorization information.

The system 210 achieves the login to the MFP 20 by the authentication based on the face image and the operation of the MFP 20 to which the login is permitted using the mobile device 240, thereby ensuring improving the convenience.

In the system 210, the authentication of the user based on the face image in the embodiment is executed. However, in the system 210, the authentication of the user may be executed based not only on the face image, but also on identification information of the user other than the face image, such as a card ID and a PIN code. The card ID may be input from a card reader (not illustrated) and the PIN code may be input from the operation unit 241.

The mobile device 240 may include at least a part of functions of at least one of the login server 60 and the authentication server 70. When the mobile device 240 includes all the functions of both the login server 60 and the authentication server 70, the system 210 does not have to include the login server 60 and the authentication server 70.

While the electronic device of the disclosure is the MFP in each embodiment described above, the electronic device may be an image forming apparatus other than the MFP, such as a printer-only machine, a FAX-only machine, a copy-only machine, and a scanner-only machine, or may be an electronic device other than the image forming apparatus, such as a PC.

The login server 60 and the authentication server 70 are separately included in each embodiment described above. However, the login server 60 and the authentication server 70 may be constituted as one server.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A system comprising:
an electronic device that ensures a login in response to login information for a login received from outside of the system; and
a login system that transmits the login information to the electronic device; wherein
the login system includes
a camera,
an authentication unit that authenticates a user,
a login information management unit that manages the login information for each user, and
an information transmitting unit that transmits the login information managed by the login information management unit for a user authenticated by the authentication unit, to the electronic device; and
the authentication unit authenticates the user based on a face image obtained with the camera.

2. The system according to claim 1, wherein:
the login system includes a mobile device;
the camera is included in the mobile device; and
the mobile device includes
an input device, and
a device operation unit that operates the electronic device in accordance with an input accepted by the input device when the login is permitted by the electronic device to which the login information is transmitted by the information transmitting unit.

3. The system according to claim 1, wherein:
the login system includes an authorization information management unit that manages authorization information indicating a restriction with respect to the electronic device for each user;
the information transmitting unit, when transmitting the login information for a user to the electronic device, transmits the authorization information managed by the authorization information management unit for the user to the electronic device; and
the electronic device, when permitting the login in response to the login information transmitted by the information transmitting unit, executes a restriction in accordance with the authorization information transmitted by the information transmitting unit.

4. A login system that transmits login information to an electronic device that ensures a login in response to login information for a login received from outside of the login system, the login system comprising:
a camera;
an authentication unit that authenticates a user;
a login information management unit that manages the login information for each user; and
an information transmitting unit that transmits the login information managed by the login information management unit for a user authenticated by the authentication unit, to the electronic device; wherein
the authentication unit authenticates the user based on a face image obtained with the camera.
